(19) United States
(12) Patent Application Publication
(10) Pub. No.: US 2026/0328222 A1
(43) Pub. Date: Oct. 22, 2026

(54) ELECTRIC WATER PUMP WITH AN OVERMOLDED HEAT CONDUCTING ELEMENT

(71) Applicants: HANON SYSTEMS EFP DEUTSCHLAND GMBH, Bad Homburg v.d. Höhe (DE); Hanon Systems EFP Canada Ltd, Concord (CA)

(72) Inventors: Stefan Olaru, Concord (CA); Ernesto Giovanni Arnoldi, Luserna San Giovanni (TO) (IT); Paolo Lincoln Maurino, Bagnolo Piemonte (CN) (IT); Kyle Mills, Etobicoke (CA); Robert Scotchmer, Concord (CA)

(21) Appl. No.: 19/181,796

(22) Filed: Apr. 17, 2025

(51) Int. Cl. F04D 29/58; B29C 45/14; B29L 31/00; F04D 29/044; F04D 29/046; F04D 29/08

(52) U.S. Cl. CPC F04D 29/5893; B29C 45/14467; F04D 29/044; F04D 29/046; F04D 29/086; F04D 29/5813; B29L 2031/7496

(57) ABSTRACT

An electric water pump is disclosed. The electric water pump comprises an impeller driven by an electrical machine. The impeller and the electrical machine are encased by a volute housing and a corresponding cover. The electrical machine comprises a rotor, a stator, and an electrical board. A sleeve is interposed between the rotor and the stator to prevent cooling fluid from contacting the stator and/or other components of the electric water pump. The sleeve includes an overmolded heat conducting element in thermal energy exchange relationship with the electrical board and/or the cooling fluid. The sleeve may further include an overmolded shaft of the electrical machine or an overmolded bushing configured to support a rotatable shaft of the electrical machine.

### FIELD

The disclosure relates to a water pump, and more particularly to an electric water pump with an overmolded heat conducting element.

### BACKGROUND

Conventional electric water pumps include an electrical machine comprising a stator, a rotor, and an electrical board. The rotor is in communication with an impeller to move fluid such as a coolant, for example. The fluid enters the water pump through an inlet in a volute housing, contacts an impeller, and is moved through an outlet in the volute housing. The rotor and stator are contained within a casing that communicates with the volute housing. The rotor and the stator are separated by a magnetic air gap that can be crossed by the magnetic flux to cause a rotational movement of the rotor during use. The rotor is in general spinning in the fluid (wet side), while the stator, or electronics (PCB) or both can be damaged by the fluid entering the dry portion of the water pump. Accordingly, the PCB and/or the stator is isolated from the fluid during use to maintain operation and prevent damage thereto.

A wet liner or sleeve with a heat sink may be employed in conventional water pumps to protect the electrical board from the fluid while preferably maximizing a heat transfer from the electrical board to the fluid. Prior art sleeves are typically: i) one-piece metal designs for high power density and thermal requirements; ii) one-piece plastic designs for low power density and thermal requirements; or iii) combination plastic and metal designs intended to provide a balance between requirements and practical packaging constraints. Additionally, in typical water pumps, the sleeve may also be a structural member, supporting a shaft and/or a rotor of the electrical machine, which increases a design complexity.

Accordingly, it is desirable to develop a sleeve for an electric water pump with an overmolded heat conducting element that preserves performance and efficiency of the water pump, while reducing complexity, packaging size, and weight as well as minimizing manufacturing cost.

### SUMMARY

In concordance and agreement with the presently described subject matter, a sleeve for an electric water pump with an overmolded heat conducting element that preserves performance and efficiency of the water pump, while reducing complexity, packaging size, and weight as well as minimizing cost, has been newly designed.

In one embodiment, a sleeve for an electric water pump, comprises: a main body; and an overmolded heat conducting element integrated with the main body, wherein the heat conducting element is in direct thermal exchange relationship with an electrical board of the electric water pump and a cooling fluid.

As aspects of some embodiments, the main body is formed from a plastic material.

As aspects of some embodiments, the heat conducting element is formed from a thermally conductive material.

As aspects of some embodiments, the heat conducting element is a stamped heat conducting element.

As aspects of some embodiments, the heat conducting element is in direct contact with the electrical board or a thermally conductive material disposed between the heat conducting element and the electrical board.

As aspects of some embodiments, the heat conducting element is in direct contact with the cooling fluid.

As aspects of some embodiments, the heat conducting element is generally disk shaped having an annular lip.

As aspects of some embodiments, the sleeve further comprises an overmolded shaft, wherein the shaft is part of an electrical machine of the electric water pump.

As aspects of some embodiments, the main body comprises an outer wall portion, an outer hub portion, an inner hub portion, and/or one or more web portions.

As aspects of some embodiments, the outer wall portion sealingly engages an inner surface of the electric water pump to form a substantially fluid-tight seal therebetween.

As aspects of some embodiments, the heat conducting element forms a closed end of the outer hub portion.

As aspects of some embodiments, an annular lip of the heat conducting element is overmolded by the outer hub portion.

As aspects of some embodiments, a shaft of the electric water pump is overmolded by the inner hub portion.

In another embodiment, a method for manufacturing a sleeve for an electric water pump, comprises: providing a heat conducting element; and integrating the heat conducting element with a sleeve using an overmolding process, wherein the heat conducting element and the sleeve form a unitary structure, and wherein the heat conducting element is configured for direct thermal exchange relationship with a cooling fluid.

As aspects of some embodiments, the method further comprises producing the heat conducting element by a stamping process.

As aspects of some embodiments, the method further comprises producing the sleeve by an injection molding process.

As aspects of some embodiments, the method further comprises providing a shaft for an electrical machine of the electric water pump.

As aspects of some embodiments, the method further comprises integrating the shaft with the sleeve using an overmolding process, wherein the shaft and the sleeve form a unitary structure.

As aspects of some embodiments, the method further comprises providing a bushing configured to support the shaft of the electrical machine of the electric water pump.

As aspects of some embodiments, the method further comprises integrating the bushing with the sleeve using an overmolding process, wherein the bushing and the sleeve form a unitary structure.

Further areas of applicability will become apparent from the description provided herein. The description and specific examples in this summary are intended for purposes of illustration only and are not intended to limit the scope of the present disclosure.

### BRIEF DESCRIPTION

The drawings described herein are for illustrative purposes only of selected embodiments and not all possible implementations, and are not intended to limit the scope of the present disclosure.

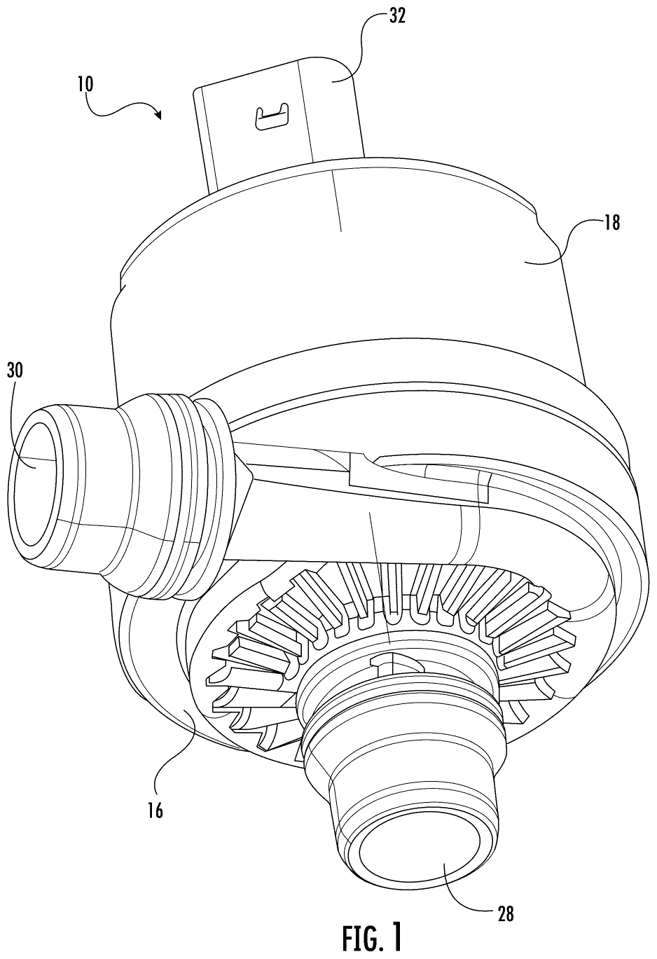

FIG. 1 is a perspective view of an electric water pump in accordance with an embodiment of the present disclosure;

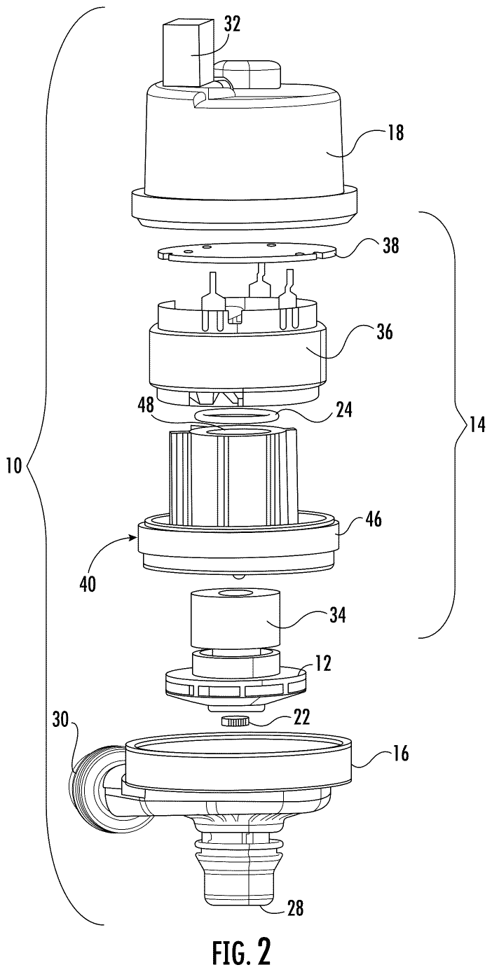

FIG. 2 is an exploded view of the electric water pump of FIG. 1;

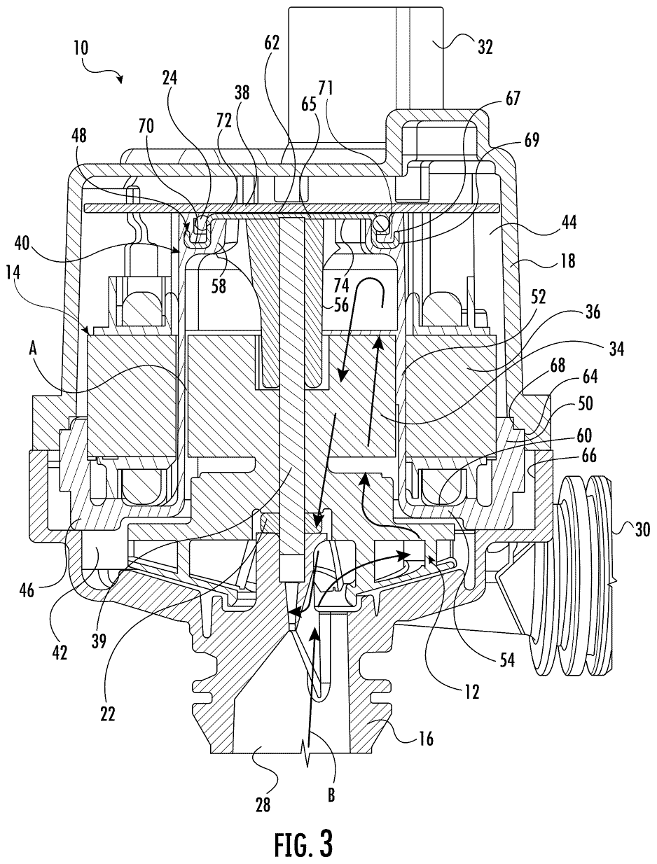

FIG. 3 is a cross-sectional view of the electric water pump of FIGS. 1 and 2 including an electrical machine and a sleeve, wherein the sleeve comprises an overmolded heat conducting element and an overmolded shaft of the electrical machine;

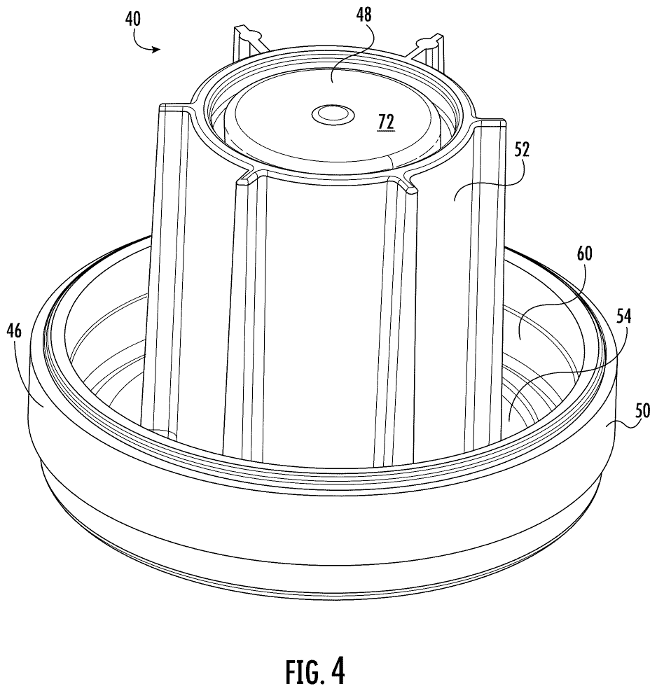

FIG. 4 is a top perspective view of the sleeve of FIGS. 2 and 3;

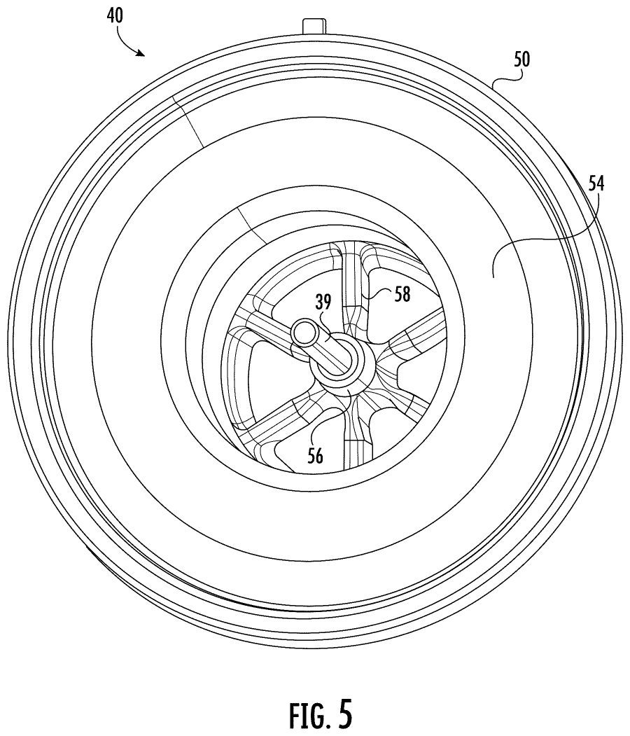

FIG. 5 is a bottom perspective view of the sleeve of FIGS. 2-4;

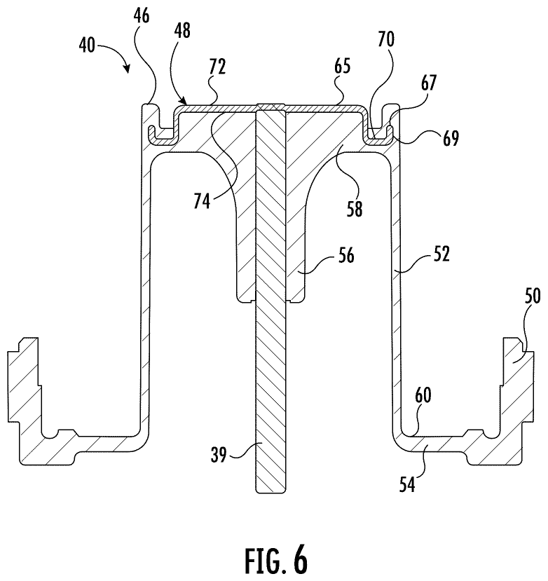

FIG. 6 is a cross-sectional view of the sleeve of FIGS. 2-5;

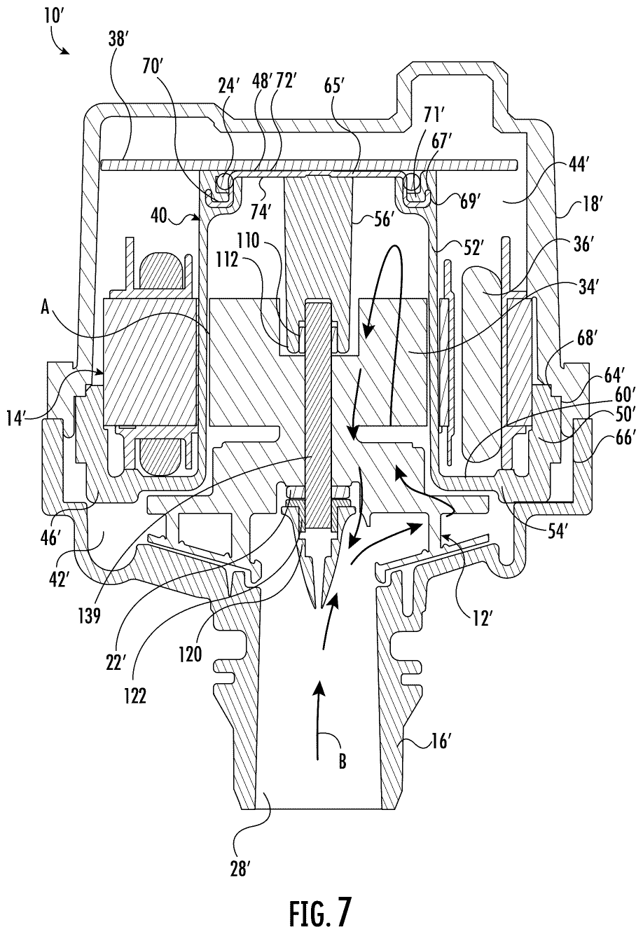

FIG. 7 is a cross-sectional view of an electric water pump including an electrical machine and a sleeve in accordance with another embodiment of the present disclosure, wherein the sleeve comprises an overmolded heat conducting element and an overmolded or inserted bushing configured to support a rotatable shaft of the electrical machine;

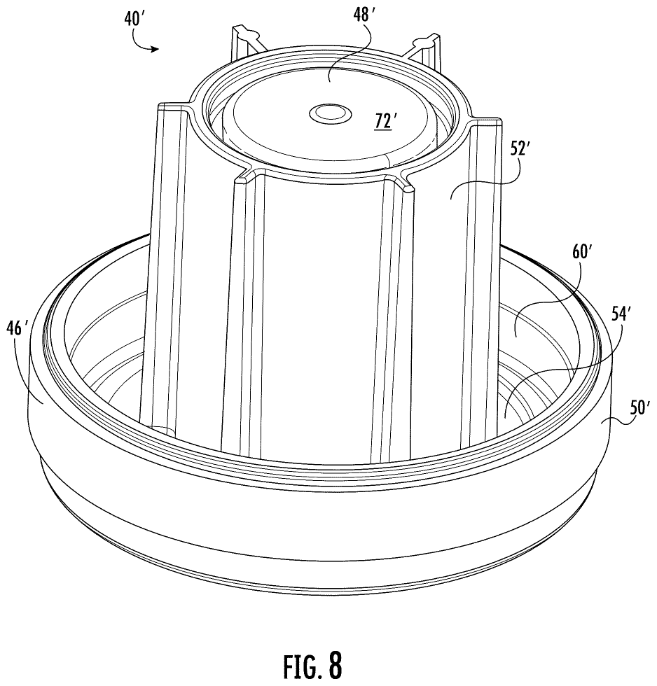

FIG. 8 is a top perspective view of the sleeve of the electric water pump shown FIG. 7;

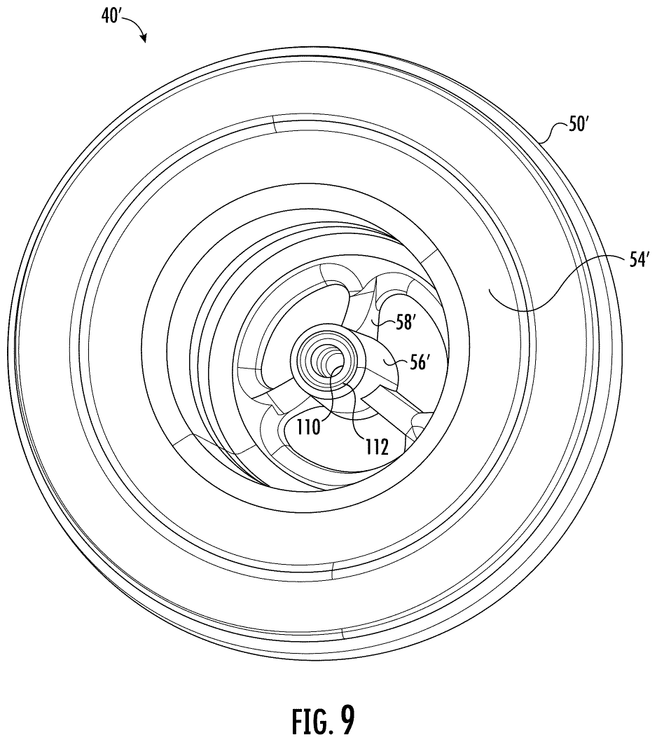

FIG. 9 is a bottom perspective view of the sleeve of FIGS. 7 and 8; and

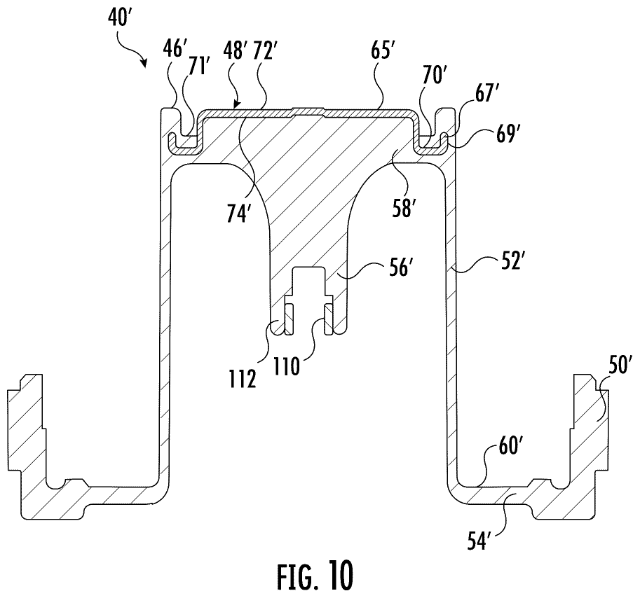

FIG. 10 is a cross-sectional view of the sleeve of FIGS. 7-9.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated.

Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

FIGS. 1-3 illustrate an electric water pump 10 according to an embodiment of the present disclosure. In some embodiments, the electric water pump 10 comprises an impeller 12 driven by an electrical machine 14. A volute housing 16 and a corresponding cover 18 are configured to encase the impeller 12 and the electrical machine 14, and other components (e.g., a bushing 22, one or more sealing elements 24, and the like) of the electric water pump 10. The volute housing 16 and the cover 18 may be coupled together by any suitable mean and method such by mechanical (e.g., fasteners), chemical, and the like, for example. The volute housing 16 includes a fluid inlet 28 for receiving an inflow of a cooling fluid (indicated as arrows in FIG. 3) and a fluid outlet 30 for distributing an outflow of the cooling fluid therefrom. As illustrated, the impeller 12 is disposed in the volute housing 16, and more particularly, in a flow path of the cooling fluid fluidly connecting the fluid inlet 28 and the fluid outlet 30. A power connection 32 may be formed in the volute housing 16 and/or the cover 18 to facilitate a supply of electrical current to the electrical machine 14.

As more clearly shown in FIG. 3, the electrical machine 14 comprises a rotor 34 (i.e., a moving component), a stator 36 (i.e., a stationary component) surrounding the rotor 34, and an electrical board 38 (e.g., a printed circuit board (PCB)) disposed adjacent the stator 36 opposite the impeller 12. The rotor 34 and the stator 36 may be separated by a magnetic air gap A. Rotation of the rotor 34 about a shaft 39 is caused by an interaction between windings of the stator 36 when supplied with the electric current, which generates magnetic fields, and the rotor magnets, which produces a torque around an axis of the rotor 34. The rotor 34 may be operably coupled to the impeller 12 to cause a rotational movement of the impeller 12 about the shaft 39 for moving the cooling fluid through the electric water pump 10. It is understood that the impeller 12 and the rotor 34 may be formed as separate and distinct components or combined as a unitary structure as depicted in FIGS. 2 and 3. An axial position of the impeller 12 along the shaft 39 may be maintained by the volute housing 16 and/or the bushing 22.

A sleeve 40 may be employed to define a fluid chamber 42 and a fluid-free chamber 44 within the electric water pump 10. The fluid chamber 42 may be in fluid communication with the fluid inlet 28 and the fluid outlet 30 of the volute housing 16 to permit a circulation of the cooling fluid therethrough. In some embodiments, the sleeve 40 may interposed between the rotor 34 and the stator 36 to permit the cooling fluid within the fluid chamber 42 to flow around the rotor 34 yet prevent the cooling fluid from contacting the stator 36 and/or the electrical board 38 in addition to other internal components of the electric water pump 10 located in the fluid-free chamber 44.

As best seen in FIGS. 4-6, the sleeve 40 comprises a main body 46 and a heat conducting element 48. The heat conducting element 48 may be in thermal energy exchange relationship with the electrical board 38 and/or the cooling fluid. In certain embodiments, the sleeve 40 further comprises the shaft 39. It is understood that main body 48, the shaft 39, and the heat conducting element 48 may be integrally formed as a unitary structure, if desired. As a non-limiting example, the main body 46 may be formed from a lightweight and/or a plastic material, the heat conducting element 48 may be formed from one or more metal, resin (e.g., synthetic resin), and/or ceramic materials, and the shaft 39 may be formed from a metal material. Preferably, the heat conducting element 48 may be formed from one or more thermally conductive materials such as a thermally conductive metal material (e.g., aluminum or aluminum alloy materials, and the like, etc.), a thermally conductive non-metal material (e.g., synthetic resins, ceramic materials, and the like, etc.), and/or a blend or mixture thereof. The main body 46, the heat conducting element 48, and the shaft 39 may be coupled together, directly or indirectly, by any suitable mechanical and/or chemical means and method. In certain embodiments, the heat conducting element 48 is spaced from the shaft 39 so that there is no contact therebetween. It is understood that each of the main body 46, the heat conducting element 48, and the shaft 39 may have any suitable size, shape, and configuration to produce a desired sleeve 40 for the electric water pump 10.

In preferred embodiments, the heat conducting element 48 and/or the shaft 39 are coupled to the main body 46 using an overmolding process. In some instances, the overmolding is part of an injection molding process. Advantageously, the overmolding process permits the heat conducting element 48 and/or the shaft 39 to be easily integrated into and interlocked with the main body 46, which reduces complexity, packaging, size and weight and also minimizes manufacturing cost of the sleeve 40 and thereby, the electric water pump 10. Further, by overmolding the heat conducting element 48 and/or the shaft 39, an overall dampening of noise, vibration, and harshness (NVH) of the electric water pump 10 may be preserved. Any improvement in NVH of the sleeve 40 and the electric water pump 10 is critical, particularly in automotive applications where reducing NVH is relentlessly pursued since it directly impacts quality and customer satisfaction. Other benefits of the overmolded heat conducting element 48 and/or the overmolded shaft 39 include, but are not limited to, increased durability and design flexibility of the sleeve 40, increased axial and/or radial support of the shaft 39, as well as decreased assembly requirements by eliminating the need for additional mechanical and/or chemical fasteners.

Referring back to FIGS. 3 and 6, the main body 46 includes an outer wall portion 50, an outer hub portion 52, a continuous web portion 54 extending between the outer wall portion 50 and the outer hub portion 52, an inner hub portion 56 configured to surround the shaft 39, and one or more web portions 58 extending between the outer and inner hub portions 52, 56. The outer wall portion 50, the outer hub portion 52, and the web portion 54 form a generally U-shaped annular channel 60. The portions 50, 52, 54, 56, 58 of the main body 46, the heat conducting element 48, and/or the shaft 39 may be integrated together using the overmolding process to form a monolithic sleeve 40. It is understood that various other designs of the main body 46 may be employed for the sleeve 40. For example, the main body 46 may be formed without the annular channel 60 if desired.

As illustrated, the heat conducting element 48 forms a closed end of the outer hub portion 52 to allow for direct contact of the heat conducting element 48 with the cooling fluid circulating in the fluid chamber 42, which results in increased thermal dissipation capacity. In some instances, the heat conducting element 48 may also abut or directly contact the electrical board 38 to facilitate a transfer of thermal energy from the electrical board 38 to the cooling fluid. In other instances, the heat conducting element 48 may be axially spaced apart from the electrical board 38 to permit a thermally conductive material 62 (e.g., a paste) to be disposed therebetween to further enhance the transfer of thermal energy from the electrical board 38 to the cooling fluid. The sealing element 24 may be disposed between the electrical board 38, the main body 46, and/or the heat conducting element 48 to form a substantially fluid-tight seal therebetween and prevent a leakage of the cooling fluid from the fluid chamber 42 into the fluid-free chamber 44.

The outer hub portion 52 axially extends through the magnetic air gap A having the rotor 34 disposed in an interior of the outer hub portion 52 around the shaft 39 and the stator 36 seated in the annular channel 60. As depicted, the outer hub portion 52 is radially and/or axially spaced from the rotor 34 and the impeller 12 to permit the rotor 34 and the impeller 12 to freely rotate. An outer circumferential surface 64 of the outer wall portion 50 may sealingly engage an inner circumferential surface 66 of the volute housing 16 and/or an inner circumferential surface 68 of the cover 18 to form a substantially fluid-tight seal therebetween and prevent a leakage of the cooling fluid from the fluid chamber 42 into the fluid-free chamber 44. One or more of the sealing elements 24 may be employed to form the substantially fluid-tight seal between the sleeve 40, the volute housing 16, and/or the cover 18.

In preferred embodiments, the heat conducting element 48 is generally disc-shaped member 65. It is understood that the heat conducting element 48 may be formed by any suitable process such as a stamping process, for example. By using the stamping process, a manufacturing time and cost to produce the heat conducting element 48 is significantly reduced. An outer peripheral edge 67 of the member 65 may be upturned to form an annular lip 69 and an annular channel 70. As depicted more clearly in FIG. 6, the annular lip 69 and/or the annular channel 70 of the heat conducting element 48 is overmolded by a portion 71 of the main body 46 as a result of the overmolding process used to produce the sleeve 40 described hereinabove. Additionally, the member 65 may further include a generally planar surface 72 and an opposing generally planar surface 74. As shown, the planar surface 72 may be configured for contact with the electrical board 38 or the thermally conductive material 62 and the opposing planar surface 74 may be configured for contact with the cooling fluid. It is understood that at least one of the planar surfaces 72, 74 may include one of more heat transfer elements (e.g., protuberances, dimples, beads, ribs, and the like) formed thereon to enhance the thermal energy exchange from the electrical board 38 to the cooling fluid. The opposing planar surface 74 may also be directly coupled to the shaft 39.

FIG. 3 illustrates a flow of the cooling fluid through the electric water pump 10, which is indicated by arrows B. In particular, the cooling fluid flows into the fluid inlet 28 around the impeller 12, through the fluid chamber 42, and out from the fluid outlet 30. Advantageously, a shape, size, and configuration of the sleeve 40 permits the flow of the cooling fluid to directly contact the planar surface 74 of the heat conducting element 48. Accordingly, the transfer of thermal energy from the electrical board 38 through the heat conducting element 48 to the cooling fluid is optimized. As described hereinabove, the electric machine 14 causes the rotation of the rotor 34 and the impeller 12, resulting in the flow of the cooling fluid through the electric water pump 10.

FIG. 7 shows an electric water pump 10′ including a sleeve 40′ (more clearly depicted in FIGS. 8-10) according to another embodiment of the present disclosure. Reference numerals for the same or substantially similar structure in respect of the description of FIGS. 1-6 are repeated in FIGS. 7-10 with a prime (′) symbol. The electric water pump 10′ and the sleeve 40′ is substantially similar to the electric water pump 10 and the sleeve 40 shown in FIGS. 1-6, except the electrical machine 14′ includes a rotatable shaft 139 and a bushing 110 configured to support an end of the rotatable shaft 139 is overmolded by a portion 112 of the inner hub portion 56′ as a result of the overmolding process described hereinabove. Advantageously, the overmolding process permits the heat conducting element 48′ and the bushing 110 to be easily integrated into and interlocked with the main body 46′, which reduces complexity, packaging, size and weight and also minimizes manufacturing cost of the sleeve 40′ and thereby, the electric water pump 10′. As depicted, an opposite end of the rotatable shaft 139 may be supported by the bushing 22′, 122 and a portion 120 of the volute housing 16′.

It should be appreciated that a flow of the cooling fluid through the electric water pump 10′ depicted in FIG. 7 by arrows B is the same or substantially similar to the flow of the cooling fluid through the electric water pump 10, therefore a description thereof is not repeated.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

1. A sleeve for an electric water pump, comprising:
a main body; and
an overmolded heat conducting element integrated with the main body, wherein the heat conducting element is in direct thermal exchange relationship with a cooling fluid, wherein a shaft is further overmolded with the main body, wherein the shaft is part of an electrical machine of the electric water pump.

2. The sleeve of claim 1, wherein the main body is formed from a plastic material.

3. The sleeve of claim 1, wherein the heat conducting element is formed from a thermally conductive material.

4. The sleeve of claim 1, wherein the heat conducting element is a stamped heat conducting element.

5. The sleeve of claim 1, wherein the heat conducting element is in direct contact with an electrical board or a thermally conductive material disposed between the heat conducting element and the electrical board.

6. The sleeve of claim 1, wherein the heat conducting element is generally disk shaped having an annular lip.

7. (canceled)

8. A sleeve for an electric water pump, comprising:
a main body;
an overmolded heat conducting element integrated with the main body, wherein the heat conducting element is in direct thermal exchange relationship with a cooling fluid; and
a bushing overmolded with the main body, wherein the bushing is configured to support a rotatable shaft of an electrical machine of the electric water pump.

9. The sleeve of claim 1, wherein the main body comprises an outer wall portion, an outer hub portion, an inner hub portion, and/or one or more web portions.

10. The sleeve of claim 9, wherein the outer wall portion sealingly engages an inner surface of the electric water pump to form a substantially fluid-tight seal therebetween.

11. The sleeve of claim 9, wherein the heat conducting element forms a closed end of the outer hub portion.

12. The sleeve of claim 9, wherein an annular lip of the heat conducting element is overmolded by the outer hub portion.

13. The sleeve of claim 9, wherein the shaft of the electric water pump is overmolded by the inner hub portion.

14. A method for manufacturing a sleeve for an electric water pump, comprising:
providing a heat conducting element;
integrating the heat conducting element with a sleeve using an overmolding process,
wherein the heat conducting element and the sleeve form a unitary structure, and
wherein the heat conducting element is configured for direct thermal exchange relationship with a cooling fluid;
providing a shaft for an electrical machine of the electric water pump; and
integrating the shaft with the sleeve using an overmolding process, wherein the shaft and the sleeve form a unitary structure.

15. The method of claim 14, further comprising producing the heat conducting element by a stamping process.

16. The method of claim 14, further comprising producing the sleeve by an injection molding process.

17. (canceled)

18. (canceled)

19. A method for manufacturing a sleeve for an electric water pump, comprising:
providing a heat conducting element;
integrating the heat conducting element with a sleeve using an overmolding process,
wherein the heat conducting element and the sleeve form a unitary structure, and
wherein the heat conducting element is configured for direct thermal exchange relationship with a cooling fluid;
providing a bushing configured to support the shaft of the electrical machine of the electric water pump; and
integrating the bushing with the sleeve using an overmolding process, wherein the bushing and the sleeve form a unitary structure.

20. (canceled)
